(19) United States
(12) Patent Application Publication
(10) Pub. No.: US 2019/0129188 A1
(43) Pub. Date: May 2, 2019

(54) F-THETA LENS AND LASER APPARATUS INCLUDING THE F-THETA LENS

(71) Applicant: Samsung Display Co., Ltd., Yongin-Si (KR)

(72) Inventors: Emil ASLANOV, Suwon-si (KR); Jekil RYU, Yongin-si (KR); Yoongyeong BAE, Goyang-si (KR); Jooseob AHN, Hwaseong-si (KR); Gyoowan HAN, Yongin-si (KR)

(21) Appl. No.: 16/178,372

(22) Filed: Nov. 1, 2018

(30) Foreign Application Priority Data
Nov. 1, 2017 (KR) 10-2017-0144932

(51) Int. Cl. G02B 27/09; G02B 26/10; B23K 26/06

(52) U.S. Cl. CPC G02B 27/0955; B23K 26/0648; G02B 26/105

(57) ABSTRACT

The laser apparatus includes a laser generator configured to generate at least one input beam traveling from one side to the other side in one direction and an optical system including an F-theta lens, which includes a plurality of spherical lenses. The F-theta lens includes a first lens including a first one surface that is convex toward the one side and a first other surface that is convex toward the other side, a second lens including a second one surface that is convex toward the one side and a second other surface that is concave toward the other side, a third lens including a third one surface that is concave toward the one side and a third other surface that is convex toward the other side, and a fourth lens including a fourth one surface that is convex toward the one side and a fourth other surface that is a plane perpendicular to the other side

This application claims priority under 35 U.S.C. § 119 to Korean Patent Application No. 10-2017-0144932, filed on Nov. 1, 2017; the entire contents of the Korean Patent Application are incorporated herein by reference.

### BACKGROUND

### 1. Field

The technical field relates an F-theta lens and a laser apparatus including the F-theta lens.

### 2. Description of the Related Art

A laser apparatus may be used for manufacturing electronic devices, such as display devices. For example, a laser apparatus may be used for cutting, cleaning, marking, scanning, crystallizing, and/or surface-modifying an object to produce a component. A laser beam generated in a laser apparatus may be adjusted to attain a useful shape, size, and/or energy density.

### SUMMARY

Embodiments may be related to an F-theta lens with satisfactory spatial efficiency and a laser apparatus including the F-theta lens.

An embodiment may be related to a laser apparatus that includes the following elements: a laser generator configured to generate at least one input beam traveling from one side to the other side in one direction; an optical system including an F-theta lens, which includes a plurality of spherical lenses, configured to convert the input beam received from the laser generator into an output beam; and a stage on which a target substrate is seated and onto which the output beam is irradiated, wherein the F-theta lens includes: a first lens disposed at the frontmost portion of the F-theta lens on an optical path and including a first one surface that is convex toward the one side and a first other surface that is convex toward the other side; a second lens disposed at a rear side of the first lens on the optical path and including a second one surface that is convex toward the one side and a second other surface that is concave toward the other side; a third lens disposed at a rear side of the second lens on the optical path and including a third one surface that is concave toward the one side and a third other surface that is convex toward the other side; and a fourth lens disposed at a rear side of the third lens on the optical path and including a fourth one surface that is convex toward the one side and a fourth other surface that is a plane perpendicular to the other side.

In an embodiment, a ratio of a focus distance of the first lens to the total focus distance of the F-theta lens may be about 2.0, a ratio of a focus distance of the second lens to the total focus distance of the F-theta lens may be about −0.31, a ratio of a focus distance of the third lens to the total focus distance of the F-theta lens may be about −0.27, a ratio of a focus distance of the fourth lens to the total focus distance of the F-theta lens may be about 0.45, and the ratios of the first to fourth lenses to the total focus distance may have an error range of about 10% or less.

In an embodiment, the laser apparatus may further include a first processing part disposed between the laser generator and the F-theta lens to change a shape of the input beam provided from the laser generator, thereby forming a first processing beam.

In an embodiment, the first processing part may include a diffractive optical element (DOE).

In an embodiment, the first processing beam may have a cross-section in a line shape.

In an embodiment, the optical system may further include a second processing part disposed at a rear side of the first processing part on the optical path to cut the first processing beam and thereby to generate a second processing beam.

In an embodiment, the second processing part may include a plurality of slits.

In an embodiment, the optical system may further include at least one galvanometer.

In an embodiment, the F-theta lens may have a working distance of about 750 mm or less.

In an embodiment, the F-theta lens may have an irradiation area of about 600 mm or more.

In an embodiment, the input beam may have a diameter of about 5 mm to about 10 mm.

In an embodiment, the laser apparatus may further include a window disposed at the rearmost portion of the F-theta lens on the optical path.

In an embodiment, the first lens may have a first thickness, the second lens may have a second thickness, the third lens may have a third thickness, the fourth lens may have a fourth thickness, the window may have a fifth thickness, and when the third thickness has a relative value of 10, the first thickness may have a value of 12.5, the second thickness may have a value of 11, the third thickness may have a value of 15, and the fifth thickness may have a value of 3.

In an embodiment, when the third thickness has a relative value of 10, a distance between the first lens and the second lens may be 6, a distance between the second lens and the third lens may be 26, the third lens and the fourth lens may be 1, and a distance between the fourth lens and the window may be 12.

In an embodiment, when the third thickness has a relative value of 10, a working distance may be 688.05.

In an embodiment, the first one surface may have a curvature radius of 337.35, the first other surface may have a curvature radius of −105.77, the second one surface may have a curvature radius of 187.83, the second other surface may have a curvature radius of 74.64, the third one surface may have a curvature radius of −79.9, the third other surface may have a curvature radius of −303.58, and the fourth one surface may have a curvature radius of 184.13.

In an embodiment, a component of each of the first to fourth lenses may include fused silica.

In an embodiment, an F-theta lens includes the following elements: a first lens disposed at the frontmost side in one direction from a light source to an image capturing surface and having a convex surface toward the light source and a convex surface toward the image capturing surface; a second lens disposed at a rear side of the first lens in the one direction and having a convex surface toward the light source and a concave surface toward the image capturing surface; a third lens disposed at a rear side of the second lens in the one direction and having a concave surface toward the light source and a convex surface toward the image capturing surface; and a fourth lens disposed at a rear side of the third lens in the one direction and having a convex surface toward the light source and a fourth other surface that is an aspherical surface to the image capturing surface.

In an embodiment, a ratio of a focus distance of the first lens to the total focus distance may be about 2.0, a ratio of a focus distance of the second lens to the total focus distance of the F-theta lens may be about −0.31, a ratio of a focus distance of the third lens to the total focus distance of the F-theta lens may be about −0.27, a ratio of a focus distance of the fourth lens to the total focus distance of the F-theta lens may be about 0.45, and the ratios of the first to fourth lenses to the total focus distance may have an error range of about 10% or less.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a schematic view of a laser apparatus according to an embodiment.

FIG. 2 is a schematic view of a third processing part of the laser apparatus illustrated in FIG. 1 according to an embodiment.

FIG. 3 is a table showing (relative) thicknesses of and (relative) distances between the lenses illustrated in FIG. 2 according to an embodiment.

FIG. 4 is a table showing curvature radii of the lenses illustrated in FIG. 2 according to an embodiment.

### DETAILED DESCRIPTION

Example embodiments are described with reference to the accompanying drawings. The described embodiments may be embodied in different forms and should not be construed as limiting. Like reference numerals may refer to like elements in the description.

Although the terms “first,” “second,” etc. may be used herein to describe various elements, these elements, should not be limited by these terms. These terms may be used to distinguish one element from another element. Thus, a first element may be termed a second element without departing from teachings of one or more embodiments. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-type (or first-set),” “second-type (or second-set),” etc., respectively.

When a first element is referred to as being “on” a second element, the first element can be directly on the second element, or one or more intervening layers may be present between the first element and the second element. When a first element is referred to as being “directly on” a second element, no intended intervening elements (except environmental elements such as air) are present between the first element and the second element. As used herein, the term “and/or” may indicate one or more of the associated items.

Spatially relative terms, such as “below”, “beneath”, “lower”, “above”, “upper” and the like, may be used herein for ease of description to describe one element or feature's relationship to another element(s) or feature(s) as illustrated in the figures. The spatially relative terms should include different directions of configurative elements in addition to directions illustrated in the figures.

The term “focal distance” may mean “focal length.”

In the figures, shapes may be modified according to manufacturing techniques and/or allowable errors.

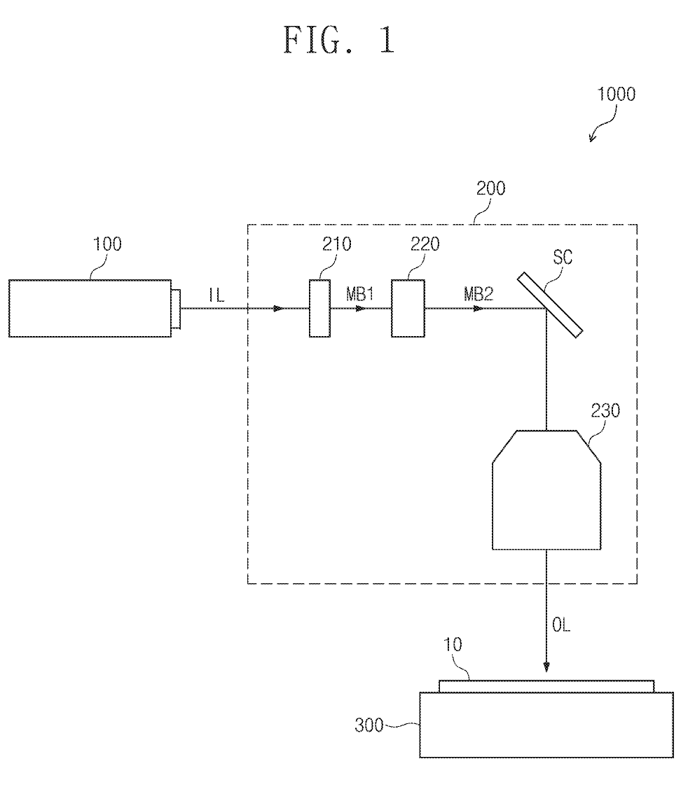

FIG. 1 is a schematic view of a laser apparatus according to an embodiment.

A laser apparatus 1000 according to an embodiment may be used for processing a target substrate 10. For example, the laser apparatus 1000 may be used for surface-boundary treatment of the target substrate 10. According to an embodiment, the laser apparatus 10000 may be used to perform a scanning process, a cleaning process, a dicing process, and/or a marking process on the target substrate 10.

Referring to FIG. 1, the laser apparatus 1000 includes a laser generator 100, an optical system 200, and a stage 300.

The laser generator 100 may be a light source. The laser generator 100 may generate an input beam IL (or generated beam IL). For example, the input beam IL may be a solid laser or an excimer laser.

In this embodiment, the input beam IL may have a substantially circular cross-sectional shape. For example, the input beam IL may have a diameter of about 5 mm to about 10 mm.

The laser apparatus 1000 generates only one input beam IL in an embodiment. In an embodiment, a plurality of input beams IL may be generated by the laser apparatus 1000.

The optical system 200 converts the input beam IL provided from the laser apparatus 100 into an output beam OL. The optical system 200 may be disposed between the stage 300 and the laser generator 100 on an optical path to irradiate the output beam OL onto the stage 300. In an embodiment, the optical path is provided from the light source that is the laser generator 100 to an image capturing surface of the target substrate 10 seated on the stage 300.

The optical system 200 includes a first processing part 210, a second processing part 220, and a third processing part 230.

The first processing part 210 may change a shape of the input beam IL provided from the laser generator 100 to form a first processed beam MB1. In an embodiment, the first processing part 210 may be a diffractive optical element (DOE). Particularly, the first processing part 210 may include a diffraction pattern on an incident surface or an emission surface. According to an embodiment, the first processed beam MB1 formed by the first processing part 210 may have a line-shaped or rectangular cross-section.

The second processing part 220 is disposed at a rear side of the first processing part 220 on the optical path. Although not shown, the second processing part 220 may include a plurality of slits. The second processing part 220 may process (e.g., cut) the first processed beam MB1 provided from the first processing part 210 to form a second processed bean MB2. For example, the second processed beam MB2 may have a shape in which an unnecessary surrounding portion of the first processed beam MB1 incident into the second processing part 220 is removed.

The third processing part 230 is disposed at a rear side of the second processing part 220 on the optical path. The third processing part 230 may adjust a size and a focus of the second processed beam MB2 provided from the second processing part 220 to form an output beam OL. According to an embodiment, the output beam OL may have a line-shaped or rectangular cross-section. For example, a cross-section of the output beam OL may have a long side having a length of about 2 mm and a short side having a size of about 30 um. In an embodiment, the output beam OL may have a different shape and/or a different size.

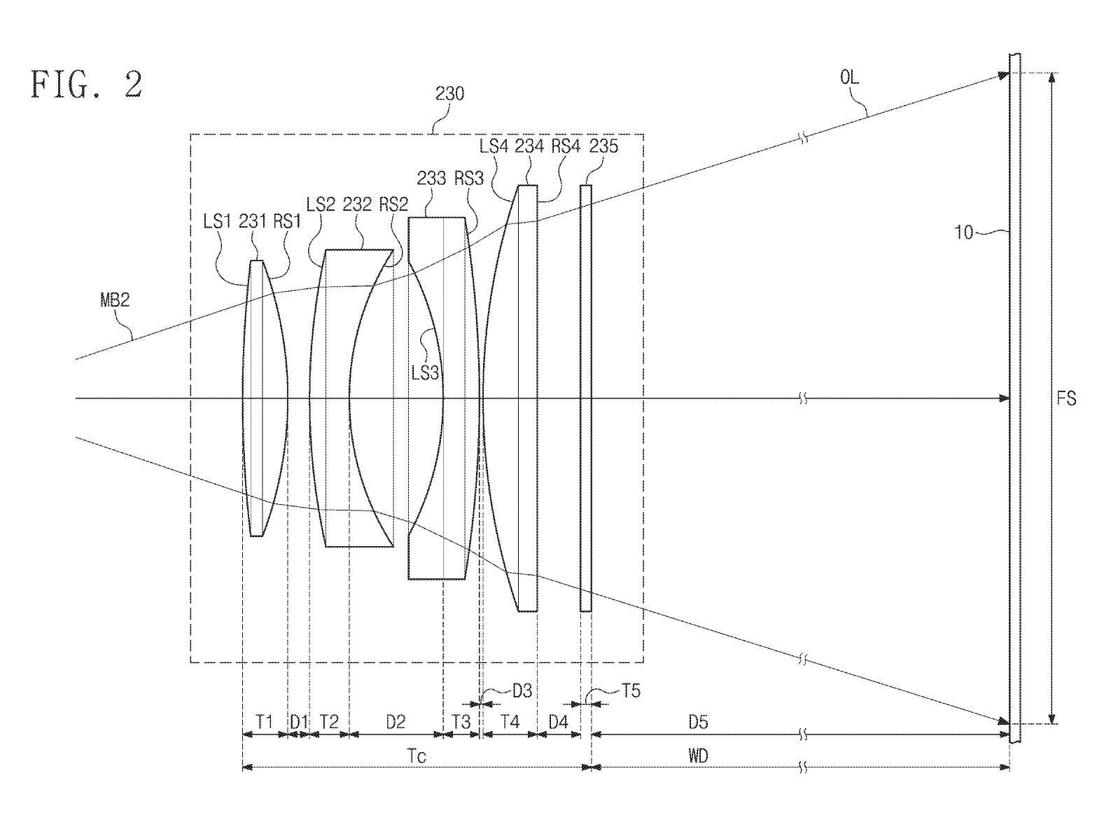

In an embodiment, the third processing part 230 may be an F-theta lens. The F-theta lens 230 includes a plurality of spherical lenses. The F-theta lens will be described in detail with reference to FIGS. 2 to 4.

The stage 300 supports the target substrate 10. The output beam OL emitted from the optical system 200 may be irradiated onto the image capturing surface of the target substrate 10. According to an embodiment, the output beam OL may modify a surface of the target substrate 10. In an embodiment, the output beam OL may modify an interlayer interface of the target substrate 10 having a lamination structure.

The optical system 200 according to an embodiment may include at least one scanner SC. The scanner SC is disposed between the second processing part 220 and the third processing part 230 on the optical path. The scanner SC may change a direction of the second processed beam MB2 so that the second processed beam MB2 provided from the second processing part 220 is directed to the third processing part 230. For example, the scanner SC may be/include a galvanometer. In an embodiment, the scanner SC may be/include a mirror.

Although the optical system 200 is disposed between the second processing part 220 and the third processing part 230 and includes one scanner SC in FIG. 1, an embodiment of the inventive concept is not limited to number and position of scanners SC. According to an embodiment, the scanner SC may be provided in plurality.

The optical system 200 according to an embodiment may further include at least one lens.

The laser apparatus according to an embodiment may further include an additional optical system for changing properties of the output beam OL.

FIG. 2 is a schematic view of the third processing part 230 of FIG. 1 according to an embodiment.

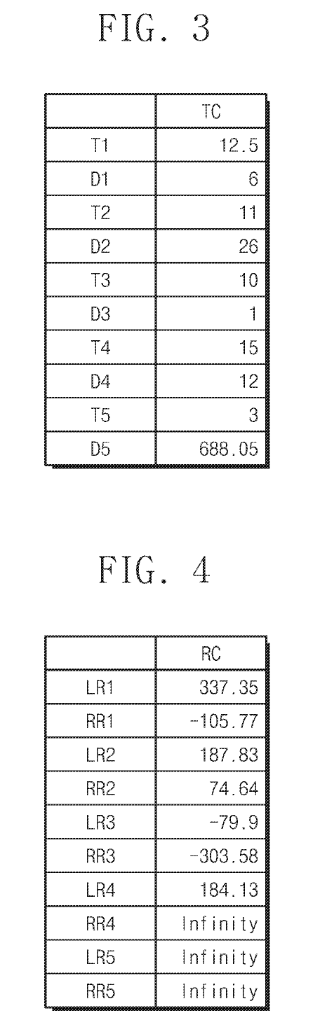

FIG. 3 is a table showing a relative thicknesses of and relative distances between the lenses illustrated in FIG. 2 according to an embodiment (with TC representing a thickness or a distance), and FIG. 4 is a table showing curvature radii of the lenses of FIG. 2 according to an embodiment (with RC representing a curvature radius).

In an embodiment, the third processing part 230 may be an F-theta lens 230.

Referring to FIGS. 2 to 4, the F-theta lens 230 includes first to fourth lenses 231, 232, 233, and 234 that are sequentially disposed backward on the optical path. According to an embodiment, each of the first to fourth lenses 231, 232, 233, and 234 may include fused silica.

The first lens 231 is disposed at the frontmost portion of the F-theta lens 230 on the optical path. The first lens 231 may be a dual convex lens (or biconvex lens). Particularly, the first lens 231 may have a convex surface toward a light source and a convex surface toward an image capturing surface. That is, the first lens 231 includes a surface LS1 that is convex (or protruding) toward the light source and a surface RS1 that is convex (or protruding) toward the image capturing surface. According to an embodiment, the surface LS1 may have a curvature radius LR1 of about 337.35 units, and the surface RS1 may have a curvature radius RR1 of about −105.77 units. A unit may be a millimeter (mm).

A center portion of the first lens 231 according to an embodiment has a first thickness T1. For example, the first thickness T1 may be the maximum thickness of the first lens 231 in the optical path direction (or optical axis) and may be about 12.5 mm (or 12.5 units).

The second lens 232 is disposed at a rear side of the first lens 231 on the optical path. According to this embodiment, a (minimum) distance D1 between the first lens 231 and the second lens 232 in the optical path direction may be about 6 mm (or 6 units).

The second lens 232 may be a meniscus lens (or convex-concave lens). Particularly, the second lens 232 may have a convex surface toward a light source and a concave surface toward an image capturing surface. That is, the second lens 232 includes a surface LS2 that is convex (or protruding) toward the light source and a surface RS2 that is concave facing the image capturing surface. According to an embodiment, the surface LS2 may have a curvature radius LR2 of about 187.33 units, and the surface RS2 may have a curvature radius RR2 of about 74.64 units.

A center portion of the second lens 232 according to an embodiment has a second thickness T2. For example, the second thickness T2 may be the minimum thickness of the second lens 232 in the optical path direction and may be about 11 mm (or 11 units).

The third lens 233 is disposed at a rear side of the second lens 232 on the optical path. According to this embodiment, a (maximum) distance D2 between the second lens 232 and the third lens 233 in the optical path direction may be about 26 mm (or 26 units).

The third lens 233 may be a meniscus lens (or concave-convex lens). Particularly, the third lens 233 may have a concave surface toward a light source and a convex surface toward an image capturing surface. That is, the third lens 233 includes a surface LS3 that is concave facing the light source and a surface RS3 that is convex toward the image capturing surface. According to an embodiment, the surface LS3 may have a curvature radius LR3 of about −79.9 units, and the surface RS3 may have a curvature radius RR3 of about −303.58 units.

A center portion of the third lens 233 according to an embodiment has a third thickness T3. For example, the third thickness T3 may be the minimum thickness of the third lens 233 in the optical path direction and may be about 10 mm (or 10 units).

The fourth lens 234 is disposed at a rear side of the third lens 233 on the optical path. According to this embodiment, a (minimum) distance D3 between the third lens 233 and the fourth lens 234 in the optical path direction may be about 1 mm (or 1 unit).

The fourth lens 234 may be a convex-planar lens. Particularly, the fourth lens 234 may have a convex surface toward a light source and an aspherical surface toward an image capturing surface. That is, the fourth lens 234 includes a surface LS4 that is convex toward the light source and a surface RS4 that is flat and is parallel to the image capturing surface. According to an embodiment, the surface LS4 may have a curvature radius LR4 of about 184.13 units, and the surface RS4 may have an infinity curvature radius RR4.

The F-theta lens 230 according to an embodiment may further include a window 235 disposed at the rearmost portion of the F-theta lens 230. According to an embodiment, a distance D4 between the window 235 and the fourth lens 234 may be about 12 mm (or 12 units).

The window 235 may have a planer aspherical surface toward each of a light source and an image capturing surface. The two planar surfaces may have infinity curvature radius LR5 and infinity curvature radius RR5, respectively. The window 235 according to this embodiment has a fifth thickness T5 in the optical path direction. For example, the fifth thickness T5 may be about 3 mm (or 3 units).

A distance between the rearmost portion of the F-theta lens 230 and the image capturing surface of the target substrate 10 is defined as a working distance (WD), also labeled D5 in FIG. 2 and FIG. 3. The working distance WD may be the minimum distance between the F-theta lens 230 and the target substrate 10. For example, the working distance WD (i.e., D5) of the F-theta lens 230 may be about 688.05 mm (or 688.05 units).

According to an embodiment, a ratio of a focus distance (f1) of the first lens 231 to the total focus distance (f) of the F-theta lens 230 is about 2.0, e.g., in a range of 90% to 110% of 2.0 or in a range of 95% to 105% of 2.0.

In an embodiment, a ratio of a focus distance (f2) of the second lens 232 to the total focus distance (f) of the F-theta lens 230 is about −0.31, e.g., in a range of 90% to 110% of −0.31 or in a range of 95% to 105% of −0.31.

In an embodiment, a ratio of a focus distance (f3) of the third lens 233 to the total focus distance (f) of the F-theta lens 233 is about −0.27, e.g., in a range of 90% to 110% of −0.27 or in a range of 95% to 105% of −0.27.

In an embodiment, a ratio of a focus distance (f4) of the fourth lens 234 to the total focus distance (f) of the F-theta lens 233 is about 0.45, e.g., in a range of 90% to 110% of 0.45 or in a range of 95% to 105% of 0.45.

The ratios each may have an error range of about 10% or less.

According to an embodiment, the F-theta lens 230 includes the lenses 231, 232, 233, and 234, which have the above-described relative dimensions and focus ratios. Thus, the working distance WD of the F-theta lens 230 may be minimized. For example, the working distance WD of the F-theta lens 230 may be about 750 mm or less. In an embodiment, the size (e.g., length Tc) of the F-theta lens 230 may be minimized.

In an embodiment, the output beam OL irradiated from the F-theta lens 230 onto the target substrate 10 may have the same shape and consistence performance when the working distance WD is within a predetermined range. The predetermined range may be defined as a field size (FS) of the F-theta lens.

According to an embodiment, the lenses 231, 232, 233, and 234 may have the above-described focus ratios to maximize the field size (FS) of the F-theta lens. For example, the field size (FS) according to an embodiment may be about 600 mm or more.

Therefore, the laser apparatus 1000 including the F-theta lens 230 may have a minimized working distance (WD) and a maximized field size (FS). That is, the laser apparatus 1000 may have satisfactory performance and sufficient spatial efficiency.

According to the embodiment, the laser apparatus may have a minimized size. In an embodiment, the laser apparatus may advantageously have a minimized operation distance and a maximized irradiation area.

Various modifications and variations can be made in the described embodiments. All practical embodiments, including any modifications or variations to the described embodiments, are within the scope of the appended claims.

What is claimed is:

1. A laser apparatus comprising:
a laser generator configured to generate a beam traveling from one side to the other side in one direction;
an optical system comprising an F-theta lens, which comprises a plurality of spherical lenses, the optical system being configured to convert the input beam received from the laser generator into an output beam; and
a stage on which a target substrate is seated and onto which the output beam is irradiated,
wherein the F-theta lens comprises:
a first lens disposed at the frontmost portion of the F-theta lens on an optical path and comprising a first one surface that is convex toward the one side and a first other surface that is convex toward the other side;
a second lens disposed at a rear side of the first lens on the optical path and comprising a second one surface that is convex toward the one side and a second other surface that is concave toward the other side;
a third lens disposed at a rear side of the second lens on the optical path and comprising a third one surface that is concave toward the one side and a third other surface that is convex toward the other side; and
a fourth lens disposed at a rear side of the third lens on the optical path and comprising a fourth one surface that is convex toward the one side and a fourth other surface that is a plane perpendicular to the other side.

2. The laser apparatus of claim 1, wherein a ratio of a focus distance of the first lens to the total focus distance of the F-theta lens is about 2.0,
a ratio of a focus distance of the second lens to the total focus distance of the F-theta lens is about −0.31,
a ratio of a focus distance of the third lens to the total focus distance of the F-theta lens is about −0.27,
a ratio of a focus distance of the fourth lens to the total focus distance of the F-theta lens is about 0.45, and
the ratios of the first to fourth lenses to the total focus distance have an error range of about 10% or less.

3. The laser apparatus of claim 1, further comprising a first processing part disposed between the laser generator and the F-theta lens and configured to change a shape of the input beam provided from the laser generator, thereby forming a first processed beam.

4. The laser apparatus of claim 3, wherein the first processing part comprises a diffractive optical element.

5. The laser apparatus of claim 3, wherein the first processed beam has a cross-section in a line shape.

6. The laser apparatus of claim 3, wherein the optical system further comprises a second processing part disposed at a rear side of the first processing part on the optical path to cut the first processed beam and thereby to generate a second processed beam.

7. The laser apparatus of claim 6, wherein the second processing part comprises a plurality of slits.

8. The laser apparatus of claim 1, wherein the optical system further comprises at least one galvanometer.

9. The laser apparatus of claim 1, wherein the F-theta lens has a working distance of about 750 mm or less.

10. The laser apparatus of claim 1, wherein the F-theta lens has an irradiation area of about 600 mm or more.

11. The laser apparatus of claim 1, wherein the input beam has a diameter of about 5 mm to about 10 mm.

12. The laser apparatus of claim 1, further comprising a window disposed at the rearmost portion of the F-theta lens on the optical path.

13. The laser apparatus of claim 12, wherein a center portion of the first lens has a first thickness,
a center portion of the second lens has a second thickness,
a center portion of the third lens has a third thickness,
a center portion of the fourth lens has a fourth thickness,
a center portion of the window has a fifth thickness, and
when the third thickness is 10 units, the first thickness is 12.5 units, the second thickness is 11 units, the fourth thickness is 15 units, and the fifth thickness is 3 units.

14. The laser apparatus of claim 13, wherein, when the third thickness is 10 units, a distance between the center portion of the first lens and the center portion of the second lens is 6 units, a distance between the center portion of the second lens and the center portion of the third lens is 26 units, a distance between the center portion of the third lens and the center portion of the fourth lens is 1 unit, and a distance between the center portion of the fourth lens and the center portion of the window is 12 units.

15. The laser apparatus of claim 14, wherein, when the third thickness has a relative value of 10 units, a working distance of the F-theta lens is 688.05 units.

16. The laser apparatus of claim 1, wherein when the first one surface has a curvature radius of 337.35 units,
the second convex surface has a curvature radius of −105.77 units,
the third convex surface has a curvature radius of 187.83 units,
the first concave surface has a curvature radius of 74.64 units,
the second concave surface has a curvature radius of −79.9 units,
the fourth convex surface has a curvature radius of −303.58 units, and
the fifth convex surface has a curvature radius of 184.13 units.

17. The laser apparatus of claim 1, wherein a component of each of the first to fourth lenses comprises fused silica.

18. An F-theta lens comprising:
a first lens disposed at the frontmost side in one direction from a light source to an image capturing surface and having a convex surface toward the light source and a convex surface toward the image capturing surface;
a second lens disposed at a rear side of the first lens in the one direction and having a convex surface toward the light source and a concave surface toward the image capturing surface;
a third lens disposed at a rear side of the second lens in the one direction and having a concave surface toward the light source and a convex surface toward the image capturing surface; and
a fourth lens disposed at a rear side of the third lens in the one direction and having a convex surface toward the light source and a fourth other surface that is an aspherical surface to the image capturing surface.

19. The F-theta lens of claim 18, wherein a ratio of a focus distance of the first lens to the total focus distance is about 2.0,
a ratio of a focus distance of the second lens to the total focus distance of the F-theta lens is about −0.31,
a ratio of a focus distance of the third lens to the total focus distance of the F-theta lens is about −0.27,
a ratio of a focus distance of the fourth lens to the total focus distance of the F-theta lens is about 0.45, and
the ratios of the first to fourth lenses to the total focus distance have an error range of about 10% or less.

20. The F-theta lens of claim 18, wherein a component of each of the first to fourth lenses comprises fused silica.
